(19) United States
(12) Patent Application Publication
(10) Pub. No.: US 2017/0214941 A1
(43) Pub. Date: Jul. 27, 2017

(54) METHOD AND APPARATUS FOR SELECTING AN INTRA PREDICTION MODE FOR USE IN MULTIVIEW VIDEO CODING (MVC)

(71) Applicant: ATI Technologies ULC, Markham (CA)

(72) Inventor: Jiao Wang, Richmond Hill (CA)

(21) Appl. No.: 15/007,748

(22) Filed: Jan. 27, 2016

(51) Int. Cl. H04N 19/597; H04N 19/11

(52) U.S. Cl. CPC H04N 19/597; H04N 19/11

(57) ABSTRACT

A method, apparatus and system uses the intra prediction modes that were used to encode a base view data block as well as the intra prediction modes used to encode neighboring data blocks to the base view data block as a set of candidate intra prediction modes for use in encoding a collocated data block in the dependent view. A sum of absolute difference (SAD) calculation may also be used to determine and select the candidate intra prediction mode that has the smallest value and hence best encoding properties for the dependent view data block. The data block in the dependent view is then encoded using the selected candidate intra prediction mode.

### BACKGROUND OF THE DISCLOSURE

The disclosure relates generally to video encoding and more particularly to motion compensation in encoding operations in multiview video coding (MVC).

Video coding standards, such as the H.264/AVC (hereinafter sometimes referred to as “H.264”) standard, the MPEG-2 standard, and other known standards are used to encode video that may then be, for example, transmitted to a device that is to implement decoding and playback of the video, stored for later transmission to such a device, etc. Additionally, in video transcoding, a compressed image stream that represents video content and has been encoded according to one standard, such as a standard used by a content provider, is decoded and then encoded according to the same or a different standard. In either case, the standard according to which the image data is encoded (or “re-encoded,” in the case of encoding that is performed according to the same standard) may be a standard that is supported by a device which is to implement or support playback of the video. Example devices that perform video encoding include, but are not limited to, content provider servers, home media servers, set-top boxes, smart phones, tablets, other handheld computers, laptop computers, desktop computers, etc.

Because of the large increase in providing of three-dimensional (3D) video services, e.g., by stereoscopic imaging where a different view is rendered for each eye to allow video to be perceived as being in 3D, H.264 and other standards have been extended to include multiview video coding (MVC). In MVC, multiple image streams constituting the same video content are captured by multiple image capturing devices, such as multiple video recording devices positioned in different locations and capturing images constituting the video content from different angles. Each image capturing device produces a corresponding single view video signal.

In one implementation of MVC, an image capturing device produces a base view and one or more additional image capturing devices produce one or more dependent views. The image data for each of the base view and the dependent view(s) includes a sequence of temporally adjacent frames, and the sequence(s) of temporally adjacent frames for the dependent view(s) are spatially adjacent to the sequence of temporally adjacent frames for the base view. These single view video signals produced by the image capturing devices are encoded by an MVC encoder to produce an MVC signal stream. When the MVC signal stream is subsequently decoded, the resulting video signal contains frames based primarily on the video frames of the base view, but also includes image information from one or more video frames from one or more dependent views.

In addition to use of MVC encoding for original encoding of image frames of video, such as for transmission of the encoded video to another device, MVC encoding may also be used in a video transcoder in order to encode or “re-encode” image frames of single view video signals (e.g., a base view signal and one or more dependent view signals) generated by a decoder of the video transcoder. In either case, the MVC encoding may involve motion compensation for the image frames of each of the single views. The motion compensation may include performing luma intra prediction on the macroblock level (e.g., on the level of 16×16 blocks of pixels in H.264) in an image frame. In luma intra prediction, the luma values for a macroblock are predicted using the luma values of nearby pixels in the same image frame. Various intra prediction modes are defined, each corresponding to a different way of using the luma values of the nearby pixels for luma intra prediction. A significant problem in luma intra prediction is the high computational load associated with selecting the intra prediction mode(s) to be used.

For example, a common approach to selecting the intra prediction mode(s) for a macroblock involves exhaustively calculating a rate distortion (RD) cost for each intra prediction mode supported for use with respect to the macroblock and then choosing the intra prediction mode(s) that yield the smallest RD cost. As known in the art, the RD cost of a particular intra prediction mode is essentially a measurement of the efficiency of that intra prediction mode, and reflects (i) the distortion between actual and predicted image data using a particular intra prediction mode versus (ii) the bit cost of encoding the predicted image data after applying the particular intra prediction mode.

In some encoding standards, a macroblock may be divided into smaller data blocks for intra prediction. For example, in H.264, three sizes of data blocks of pixels are defined for luma intra prediction: 4×4, 8×8, and the 16×16 macroblock. The exhaustive RD cost calculation for a macroblock may involve, for each smaller data block size that is available with respect to that macroblock: calculating the RD cost for each supported luma intra prediction mode for each data block of that size within the macroblock; identifying, for each data block of that size, the luma intra prediction mode with the smallest RD cost and further identifying what that smallest RD cost is; and adding up the smallest RD costs of each of the data blocks of that size within the macroblock to yield a smallest total RD cost for luma intra prediction of the macroblock when the macroblock is divided into data blocks of that size.

The exhaustive RD cost calculation for a macroblock may further involve calculating the RD cost for each luma intra prediction mode that is supported for luma intra prediction for the macroblock as a whole, identifying the luma intra prediction mode for the macroblock as a whole that has the smallest RD cost, and identifying that smallest RD cost. The encoder may then compare the smallest RD cost corresponding to luma intra prediction for the macroblock as a whole to the smallest total RD cost(s) for luma intra prediction of the macroblock as divided into each smaller available data block size. Finally, the encoder may identify the smallest of these RD costs, the associated data block size and mode(s), and perform luma intra prediction of the macroblock using the associated mode(s) and data block size as determined in the manner described above.

The computational load associated with such operations is extremely high. When such operations are performed for multiple views, as in MVC, this high computational cost only increases further. Depending upon considerations such as the fidelity requirements of the video playback environment, whether the video playback involves large video files and/or concurrent playback of multiple video files, and so on, this computational load may, for example, interfere with the ability to view the video content in real time (e.g., in the case of transcoding, as the video content is transcoded) and/or may result in reduced-quality video playback. As user requirements and the capabilities supported by devices used for video playback continue to increase, the computational load associated with the above-described RD cost calculations with MVC will become increasingly unacceptable.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram of an apparatus in accordance with one example set forth in the disclosure;

FIG. 2 is a block diagram of a system in accordance with one example set forth in the disclosure;

FIG. 3 is a functional block diagram of an enhanced intra prediction mode selection MVC encoder in accordance with one example set forth in the disclosure;

FIG. 4 is illustrates a graphical representation of a set intra prediction directions;

FIG. 5 is a diagram illustrating an example of 4×4 pixel coding block and neighboring pixels;

FIG. 6 is a flowchart illustrating one method for selecting an intra prediction mode for use in multiview video coding in accordance with one example set forth in the disclosure;

FIG. 7 is a functional block diagram of an example of an enhanced intra prediction mode selection encoder portion motion compensation logic in accordance with one example set forth in the disclosure;

FIG. 8 is a diagram illustrating collocation of data blocks between a base view picture and a dependent view picture;

FIG. 9 is a flowchart illustrating one method for selecting an intra prediction mode for use in multiview video coding in accordance with one example set forth in the disclosure; and

FIG. 10 is a flowchart illustrating one method for selecting an intra prediction mode for use in multiview video coding in accordance with one example set forth in the disclosure.

### DETAILED DESCRIPTION OF THE PREFERRED EMBODIMENTS

Briefly, in one example, a method, apparatus and system uses the intra prediction modes that were used to encode a base view data block as well as the intra prediction modes used to encode neighboring data blocks to the base view data block as a set of candidate intra prediction modes for use in encoding a collocated data block in the dependent view. A sum of absolute differences (SAD) calculation may also be used to determine and select the candidate intra prediction mode that has the smallest value and hence best encoding properties for the dependent view data block. The data block in the dependent view is then encoded using the selected candidate intra prediction mode.

The system, apparatus, and method may determine a plurality of differences between a data block of the image corresponding to a dependent view and predicted versions of the data block of the image corresponding to the dependent view as predicted using a first candidate prediction mode that was used in encoding a collocated data block in a corresponding base view, and a plurality of second candidate intra prediction modes that were used in encoding neighboring blocks of the collocated data block of the base view. The system, apparatus and method may select one of the plurality of first and second candidate intra prediction modes as a final intra prediction mode for encoding the data block of the image corresponding to the dependent view based on the plurality of determined differences. In one example, the differences are determined using a SAD calculation between an original block in the dependent view and the predicted block at the same image location and the SAD value that is the smallest among the multiple candidate prediction modes is selected as the intra prediction mode to encode the data block of the dependent view.

In another example, selecting one of the plurality of first and second candidate intra prediction modes as a final intra prediction mode for encoding the image block of the dependent view can be performed by determining an initial best candidate intra prediction mode for encoding the data block of the image corresponding to the dependent view as predicted using each of the plurality of first and second candidate intra prediction modes and evaluating the initial best candidate intra prediction mode and one or more additional candidate intra prediction modes to select the final intra prediction mode wherein the additional candidate intra prediction modes are adjacent prediction directions to the initial best candidate intra prediction mode.

In another example, the method, apparatus and system may determine that the data block of the dependent view is at an edge of the frame location and may employ a limited number of candidate intra prediction modes to encode edge data blocks compared to first and second candidate intra prediction modes that are available for use in encoding other data blocks in a dependent view that have surrounding data blocks, such as other non-edge located data blocks.

In one embodiment, a system, an apparatus and a method reduce the computational load associated with selecting an intra prediction mode for use in multiview video coding (MVC). The system and apparatus may include logic that may perform actions as described below to reduce the computational load. The system and apparatus may be or may include a device having video encoding capability, such as a content provider server, home media server, set-top box, smart phone, tablet, other handheld computer, laptop computer, desktop computer, etc. Thus, the system and apparatus may be or may include a video encoder, which in turn may include the aforementioned logic that reduces the computational load.

In some embodiments, the system and apparatus may additionally or alternatively include a video transcoder. An encoder of the video transcoder may include logic to reduce the computational load associated with selecting an intra prediction mode for an encoding or re-encoding operation performed by the transcoder. In some embodiments, the system and apparatus may also include one or more processors that decode output MVC image data that is encoded according to techniques such as those described herein. Thus, the one or more processors may generate output MVC image data. In some embodiments, the system and apparatus may also include a display, and the one or more processors may provide the output MVC image data for display on the display.

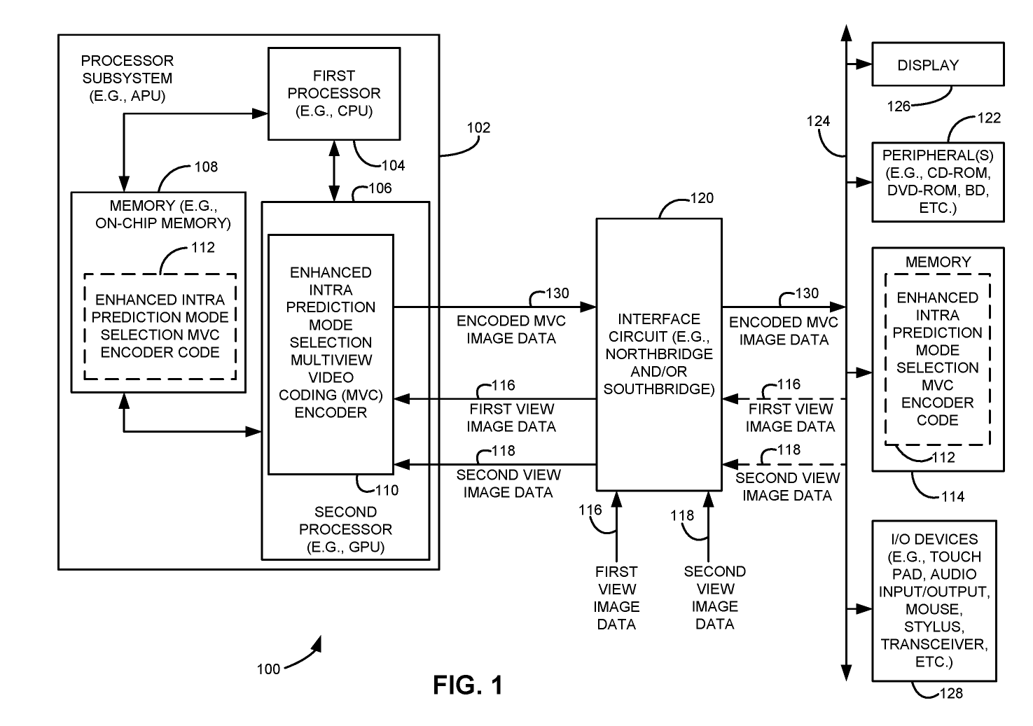

FIG. 1 is a functional block diagram illustrating an example apparatus 100 that implements enhanced, computationally-efficient selection of an intra prediction mode for use in encoding a data block of an image corresponding to a dependent view in multiview video coding that is dependent upon a base view. In particular, the example apparatus 100 implements selection of the intra prediction mode based on intra prediction modes used in encoding a data block and its neighboring data blocks of an image corresponding to the base view.

In this example, the apparatus 100 is any suitable device supporting video encoding and, in some cases, video transcoding and/or playback capability, such as but not limited to a content provider server, home media server, set-top box, smart phone, tablet, other handheld computer, laptop computer, desktop computer, etc. For purposes of illustration only, the apparatus 100 will be described as a computing device having a processor subsystem 102, which includes a first processor 104 such as a central processing unit (CPU), a second processor 106 such as a graphics processing unit (GPU), and a memory 108, such as an on-chip memory or off-chip memory.

If desired, the processor subsystem 102 may be an accelerated processing unit (APU), which as known in the art includes one or more CPU cores and one or more GPU cores on the same die. Such an APU may be, for example, an APU as sold by Advanced Micro Devices, Inc. (AMD) of Sunnyvale, Calif. Alternatively, one or more of the first and second processors 104 and 106 may perform general-purpose computing on GPU (GPGPU), may include one or more digital signal processors (DSPs), one or more application-specific integrated circuits (ASICs), or the first and second processors 104 and 106 may be any suitable processors.

The apparatus 100 includes an enhanced intra prediction mode selection multiview video coding (MVC) encoder 110 that implements the enhanced intra prediction mode selection for use in MVC. The enhanced intra prediction mode selection MVC encoder 110 may be implemented as logic, such as hardware implemented on the first processor 104 and/or the second processor 106. The enhanced intra prediction mode selection MVC encoder 110 may also be implemented as discrete logic, a state machine, one or more programmable processors, and/or other suitable hardware.

The enhanced intra prediction mode selection MVC encoder 110 may also be implemented as one or more processors executing suitable stored instructions, such as the second processor 106 (e.g., a GPU) as shown in FIG. 1 and/or the first processor 104; or as one or more processors in combination with executable instructions executable by the one or more processors and stored on a computer readable storage medium 108 where the executable instructions, when executed by the one or more processors, cause the one or more processors to perform the actions performed by the enhanced intra prediction mode selection MVC encoder 110 as further described herein. For example, the executable instructions may be stored as enhanced intra prediction mode selection MVC encoder code 112 in the memory 108 or, if desired, in an additional memory 114 (memory 108 and 114 may be a random access memory (RAM), a read only memory (ROM), or any suitable storage medium). The enhanced intra prediction mode selection MVC encoder 110 may also be implemented in any other suitable manner such as but not limited to any suitable combination of the example implementations described above.

The enhanced intra prediction mode selection MVC encoder 110 may receive, via an interface circuit 120, first view image data 116 including, for example, data blocks of an image frame corresponding to a base view, and second view image data 118 including, for example, data blocks of an image frame corresponding to a dependent view. The enhanced intra prediction mode selection MVC encoder 110 may then receive first view image data and second view image data for subsequent image frames, and so on. The enhanced intra prediction mode selection MVC encoder 110 determines a plurality of differences between the data block of the image corresponding to the dependent view and predicted versions of the data block of the image corresponding to the dependent view as predicted using each of a of first candidate prediction mode and a plurality of second candidate intra prediction modes that were used in encoding a collocated data block in the corresponding base view. The plurality of second candidate intra prediction modes were used in encoding neighboring blocks of the collocated data block of the base view. The enhanced intra prediction mode selection MVC encoder 110 selects one of the plurality of first and second candidate intra prediction modes as a final intra prediction mode for encoding the data block of the image corresponding to the dependent view based on the plurality of differences. The enhanced intra prediction mode selection MVC encoder 110 encodes the data block of the image corresponding to the dependent view using the selected final intra prediction mode as a component of the encoded MVC image data 130. Another component is the encoded base view data.

The first view image data 116 and the second view image data 118 may be compressed bitstreams and may be provided by any suitable image source or sources and may get uncompressed via an interface or encoder 110. For example, the first and second view image data 116 and 118 may be streamed from any suitable server including any suitable Internet website, or may be received from a further additional memory such as a dynamic random access memory (DRAM) or ROM (not shown in FIG. 1) to which the first and second view image data 116 and 118 has been previously downloaded. For example, the first and second view image data 116 and 118 may have been previously downloaded in response to a user selection via a website to download particular video content. The interface circuit 120 may be or may include a Northbridge and/or a Southbridge, for example.

In some embodiments, as shown by the dashed communication link carrying the first and second view image data 116 and 118, the first and second view image data 116 and 118 may be received from one or more peripheral devices 122, which may be, for example, a Compact Disc Read-Only Memory (CD-ROM), a DVD Read-Only Memory (DVD-ROM), and/or a Blu-ray Disc (BD). In this example, the first and second view image data 116 and 118 is received from the one or more peripheral devices 122 via an expansion bus 124 of the apparatus 100. The expansion bus 124 may further connect to, for example, a display 126, the additional memory 114, and one or more input/output (I/O) devices 128 such as a touch pad, audio input/output devices, a mouse, a stylus, a transceiver, and/or any other suitable input/output device(s).

In any event, after performing the enhanced intra prediction mode selection for use in MVC as described herein, the enhanced intra prediction mode selection MVC encoder 110 may encode the first and second view image data 116 and 118, using the selected intra prediction mode to encode the second view image data 118, and then process the encoded first view image data and the encoded second view image data to generate encoded MVC image data 130. The below-described enhanced intra prediction mode selection for a data block of an image corresponding to the second view, and encoding of first view image data, may be repeated in order to provide encoded MVC image data 130 for an entire image frame incorporating the multiple views of MVC, and then for a next subsequent image frame, and so on. The encoded MVC image data 130 may be provided via the interface circuit 120 to, for example, the memory 114 for storage, one or more of the I/O devices 128 for transmission to another device, etc.

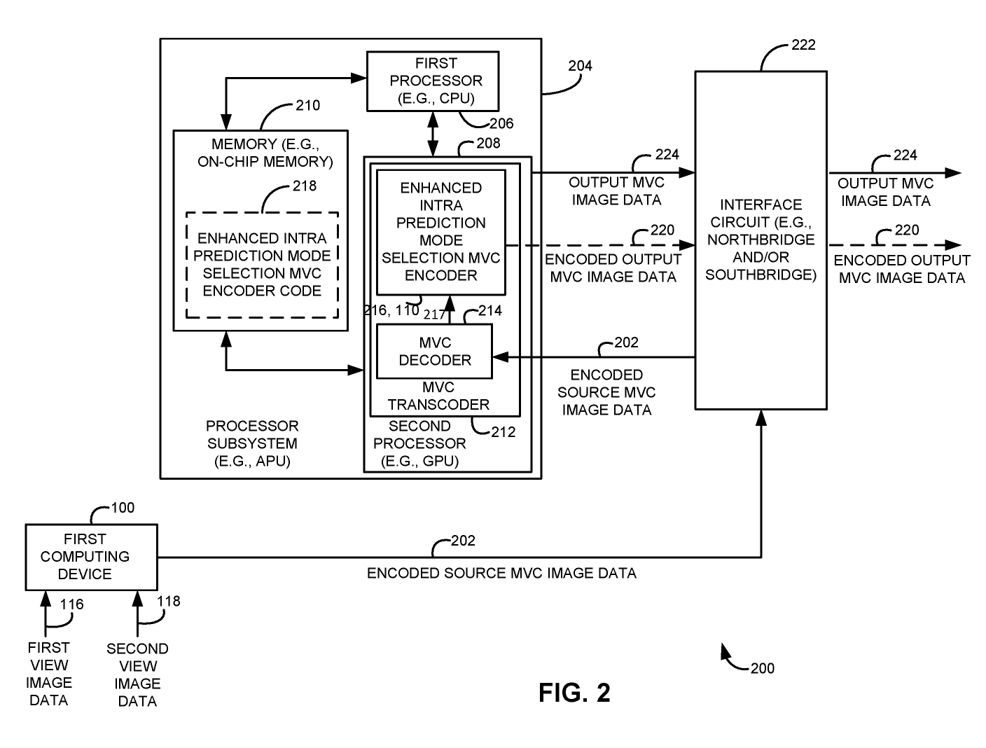

FIG. 2 is a functional block diagram illustrating an example system 200 that implements enhanced, computationally-efficient selection of an intra prediction mode(s) for use in encoding data block(s) in multiview video coding, according to an example embodiment. In the example of FIG. 2, the system 200 includes the example apparatus 100 of FIG. 1, denoted as a first computing device, though as discussed with respect to FIG. 1 the example apparatus 100 may be any suitable device supporting video encoding. In the example of FIG. 2, the system 200 also includes aspects of another apparatus similar to the computing device 100, though the system 200 may include any other suitable device(s) and/or aspect(s) thereof as will be understood in light of the present disclosure. For ease of illustration, FIG. 2 shows the first computing device 100 receiving first view image data 116 and second view image data 118 as discussed with respect to FIG. 1.

The first computing device 100 outputs encoded source MVC image data 202 based on the first and second view image data 116 and 118. The encoded source MVC image data 202 may, in one embodiment, be the encoded MVC image data 130 of FIG. 1 as output by, for example, one of the I/O devices 128. In another embodiment, the encoded source MVC image data 202 may be encoded MVC image data where enhanced intra prediction mode selection, such as that implemented by the enhanced intra prediction mode selection MVC encoder 110 as further described below, has not been used within the first computing device 100. For example, the first computing device 100 may include an initial encoder that encodes both the first and second view image data 116 and 118 using conventional intra prediction mode selection techniques and then processes the resulting encoded first view image data and encoded second view image data to provide the encoded source MVC image data 202.

For purposes of illustration, the additional apparatus of the system 200 is shown as including aspects of a computing device such as a processor subsystem 204 (e.g., an APU similar to that described with respect to FIG. 1), a first processor (e.g., CPU) 206, a second processor (e.g., GPU) 208, and memory 210, such as on-chip memory. As shown in FIG. 2, the system 200 also includes an MVC transcoder 212. The MVC transcoder 212 may include an MVC decoder 214 and an enhanced intra prediction mode selection MVC encoder 216.

The enhanced intra prediction mode selection MVC encoder 216 may, in one embodiment, be implemented similar to the enhanced intra prediction mode selection MVC encoder 110 of FIG. 1. In this embodiment, it is noted that instead of receiving the first and second view image data 116 and 118 as inputs, the enhanced intra prediction mode selection MVC encoder 216 may receive decoded first view image data and decoded second view image data 217. The decoded first view image data 217 may include one or more data blocks of an image(s) corresponding to the first view (base view), and the decoded second view image data may include a data block of an image corresponding to the second view (dependent view), as a result of the MVC decoder 214 decoding the encoded source MVC image data 202.

The enhanced intra prediction mode selection MVC encoder 216 may encode the decoded first view image data (e.g., one or more data blocks of an image(s) corresponding to the first view) and the decoded second view image data (e.g., a data block of an image corresponding to the second view) using, for example, enhanced intra prediction mode selection to select the intra prediction mode for encoding the data block of the image corresponding to the second view. Additionally, the enhanced intra prediction mode selection MVC encoder 216 may process the one or more encoded data blocks of the image corresponding to the first view and the encoded data block of the image corresponding to the second view to generate encoded output MVC image data 220, which may be transmitted or stored via an interface circuit 222 in a manner similar to transmission or storage of the encoded MVC image data 130 via the interface circuit 120. The encoded output MVC image data 220 may then, for example, be decoded by one or more processors (not shown), such as one or more GPUs or other suitable processors, such as after being transmitted to the one or more processors via the interface circuit 222.

In another embodiment, after the enhanced intra prediction mode selection MVC encoder 216 generates the encoded output MVC image data 220, the second processor 208 receives the encoded output MVC image data 220 and decodes the encoded output MVC image data 220 to generate output MVC image data 224. The output MVC image data 224 may be, for example, provided via the interface circuit 222 for display on a display in the system 200.

The various logic elements, and one or both of the decoder portion 214 and the encoder portion 216, described herein may be implemented in any suitable manner. For example, logic of the decoder portion 214 and/or the encoder portion 216 may be implemented as circuitry, such as hardware implemented on the first processor 104 and/or the second processor 106, as discrete logic, a state machine, one or more programmable processors, and/or other suitable hardware. In one example, the decoder portion 200 and the encoder portion 202, may be implemented as processors executing software such as the second processor 106 and/or the first processor 104; wherein the executable instructions are stored on a computer readable storage medium. The various elogic, and one or both of the decoder portion 2214 and the encoder portion 214, may also be implemented in any other suitable manner such as but not limited to any suitable combination of the example implementations described above, and may be implemented in whole or in part as physically distinct elements or may be understood as logical elements that are part of the same physical element.

In operation, the enhanced intra prediction mode selection MVC encoder 216, like the encoder 110, determines a plurality of differences (such as SAD values between the data block of the image corresponding to the dependent view and predicted versions of the data block of the image corresponding to the dependent view as predicted, using a first candidate intra prediction mode that was used in encoding a collocated data block in the corresponding base view and a plurality of second candidate intra prediction modes that were used in encoding neighboring blocks of the collocated data block of the base view.

The enhanced intra prediction mode selection MVC encoder 216 selects one of the plurality of first and second candidate intra prediction modes as a final intra prediction mode for encoding the data block of the image corresponding to the dependent view based on the plurality of differences. For example, the one or more neighboring data blocks may be four additional data blocks, located above, below, to the left of, and to the right of the data block of the image corresponding to the collocated data block in the base view for which an intra prediction mode for encoding is selected. In another example, the one or more neighboring data blocks may be eight additional data blocks that surround the collocated data block of the image corresponding to the data block for the dependent view for which an intra prediction mode for encoding was selected, e.g., so that the data block for which the intra prediction mode was selected is at the center of a three-data-block by three-data-block arrangement that includes the eight additional data blocks.

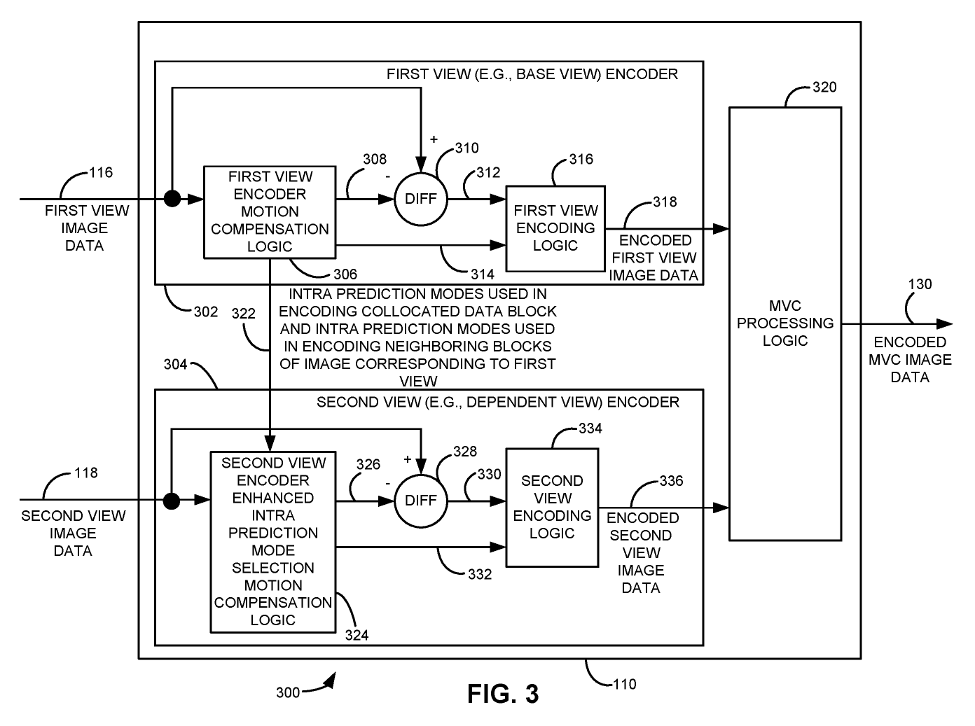

FIG. 3 is a functional block diagram of the enhanced intra prediction mode selection MVC encoder 110, according to an example embodiment. The implementation of the MVC encoder 110 as shown in FIG. 3 may also be used to implement the enhanced intra prediction mode selection MVC encoder 216, with different inputs thereto as discussed above. The enhanced intra prediction mode selection MVC encoder 110 may include a first view (e.g., base view) encoder 302 and a second view (e.g., dependent view) encoder 304. The first view encoder 302 may include first view encoder motion compensation logic 306, which may receive the first view image data 116 and perform conventional RD calculations to select an intra prediction mode for encoding one or more data blocks of the image corresponding to the first view that are included in the first view image data 116. The first view encoder motion compensation logic 306 may output a first view prediction 308 for each of the one or more data blocks of the image corresponding to the first view by selecting an intra prediction mode for encoding each of the one or more data blocks based on RD calculations as known in the art. For each of the one or more data blocks of the image corresponding to the first view, a first subtractor 310 may subtract the prediction 308 from the first view image data 116 to determine a first residue 312 between the data block of the image corresponding to the first view and the first view prediction 308 of the data block. The first view encoder motion compensation logic 306 may also output first view selected intra prediction mode information 314 indicating the intra prediction mode selected for each of the one or more data blocks of the image corresponding to the first view.

The first view encoder 302 may include first view encoding logic 316 that receives, for each of the one or more data blocks of the image corresponding to the first view, the first residue 312 and the first view selected intra prediction mode information 314. For each of the one or more data blocks of the image corresponding to the first view, the first view encoding logic 316 may then, for example, transform, quantize, and entropy encode the residue 312 according to the selected intra prediction mode for the data block as known in the art.

The above-described operations may be repeated for each of the one or more data blocks, and for each remaining data block of an entire image frame corresponding to the first view, in order to perform intra prediction and encoding for an entire image frame (and subsequent image frames) corresponding to the first view. The first view encoding logic 316 may provide encoded first view image data 318 to MVC processing logic 320 for generation of encoded MVC image data 130 that includes data for multiviews. The encoded output image data 130 after enhanced intra prediction mode selection may be provided to any suitable device or devices for decoding and/or, for example, for suitable video playback after such decoding.

The second view encoder 304 includes enhanced intra prediction mode selection motion compensation logic 324 that is used in implementing enhanced intra prediction mode selection so as to reduce the computational load in selecting an intra prediction mode for use in encoding data blocks in dependent views. The second view encoder 304 also includes a second view encoding logic 334 that outputs encoded second view image data 336 to the MVC processing logic 320. A subtractor 328 is used in a similar manner as the subtractor 310 which subtracts a prediction 326 of the dependent view image data 118 to determine a residue 330 between the data block of the image corresponding to the dependent view and a prediction 326 of the data block using the candidate intra prediction modes 322 used in encoding collocated data block and intra prediction modes used in encoding neighboring blocks of image corresponding to the base view. As previously noted, the logic in the second view encoder 304 may be any suitable logic including portions of one or more programmed processors, state machines, or any other suitable combination of hardware and executable instructions. The final selected intra prediction mode 332 will be sent to the second view encoding logic 334. The block 324 will check all intra prediction candidates to determine the final intra prediction mode 332 which has the lowest SAD value.

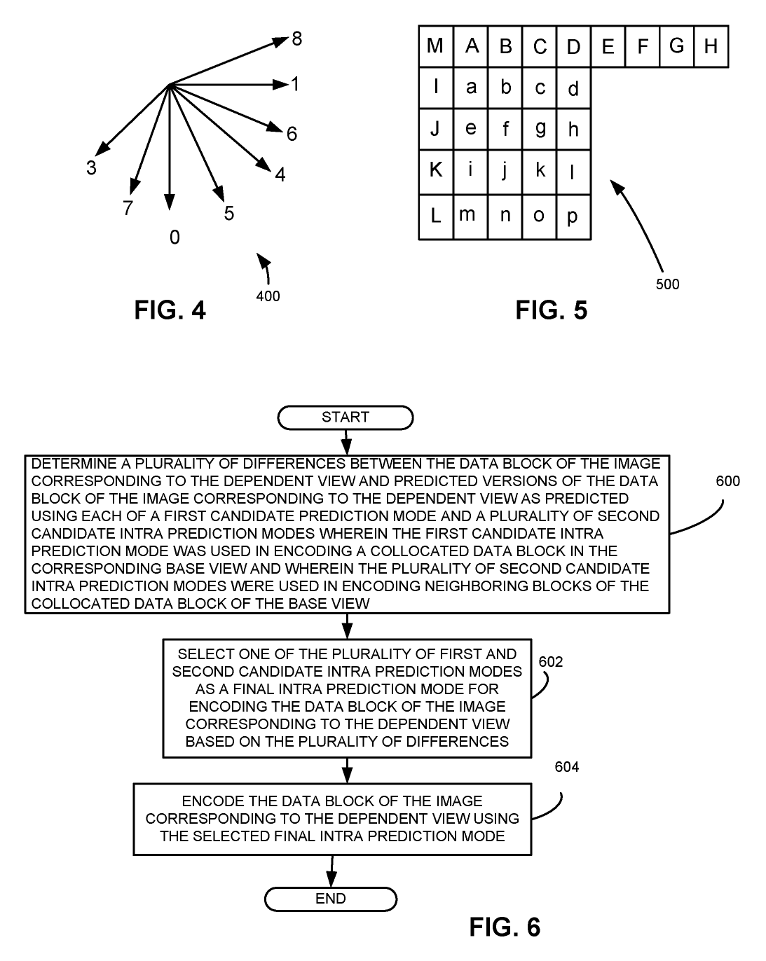

FIG. 4 illustrates a graphical representation of a set of potential intra prediction modes 400 and their directions for a 4×4 data block (e.g., four pixels by four pixels a-p). For the example in H.264, a 4×4 data block has nine potential luma intra prediction modes: mode 0 (vertical), mode 1 (horizontal), mode 2 (DC; not shown in FIG. 3 as explained below), mode 3 (diagonal down left), mode 4 (diagonal down right), mode 5 (vertical right), mode 6 (horizontal down), mode 7 (vertical left), and mode 8 (horizontal up).

FIG. 5 illustrates a graphical representation of the set of pixels a-p 500 including a 4×4 data block of pixels for which luma values are to be predicted and the information needed to predict the luma values of the 4×4 data block of pixels. The 4×4 data block 500 is designated by pixels “a” through “p,” and the luma values of a subset of neighboring (adjacent) pixels A-M are used to predict the luma values of the 4×4 data block including pixels “a” through “p” depending upon the selected intra prediction mode. For example, where mode 1 is selected as the intra prediction mode, the luma values of pixels “a”, “b”, “c”, and “d” are predicted by the luma value of neighboring pixel I. As known in the art, the prediction of the luma values of pixels “a” through “p” based on other intra prediction modes shown in FIG. 4 is similarly performed in a manner that takes the direction of the selected intra prediction mode into account. As further known in the art, mode 2 (DC), which is not shown in FIG. 3, takes the mean of the luma values of neighboring pixels A, B, C, D, I, J, K, and L as the prediction for the luma values of the current 4×4 data block of pixels “a” through “p.”

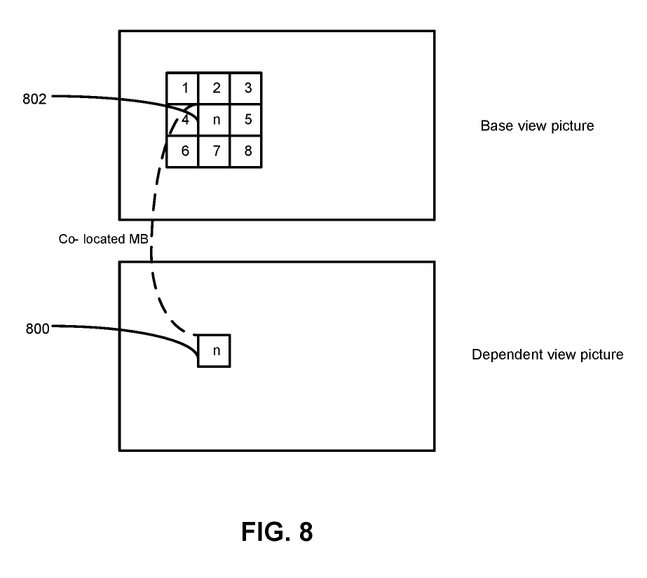

FIG. 6 illustrates one example of a method for selecting an intra prediction mode for use in multiview coding carried out, for example, by enhanced intra prediction mode selection multiview coding encoder 110, or 216. As shown in block 600, the method includes determining a plurality of differences between the data block of the image corresponding to the dependent view and a predicted version of the data black of the image corresponding to the dependent view as predicted using each of a first candidate intra prediction mode, such as that from a collocated block in a base view, and a plurality of second candidate intra prediction modes that were used in encoding neighboring blocks of the collocated data block of the base view. Referring also to FIG. 8, block 800 is the data block of the image corresponding to a dependent view and block 802 is a collocated data block in the corresponding base view. Blocks 1-8 are neighboring blocks of the collocated data block 802. The intra prediction modes used to encode block 802 and blocks 1-8 are used as candidate intra prediction modes to encode data block 800.

As shown in block 602, the method includes selecting one of the plurality of first and second candidate intra prediction modes as a final intra prediction mode for encoding the data block 800 based on the plurality of differences that were calculated in block 600. As shown in block 604, the method includes encoding the data block 800 using the selected final intra prediction mode.

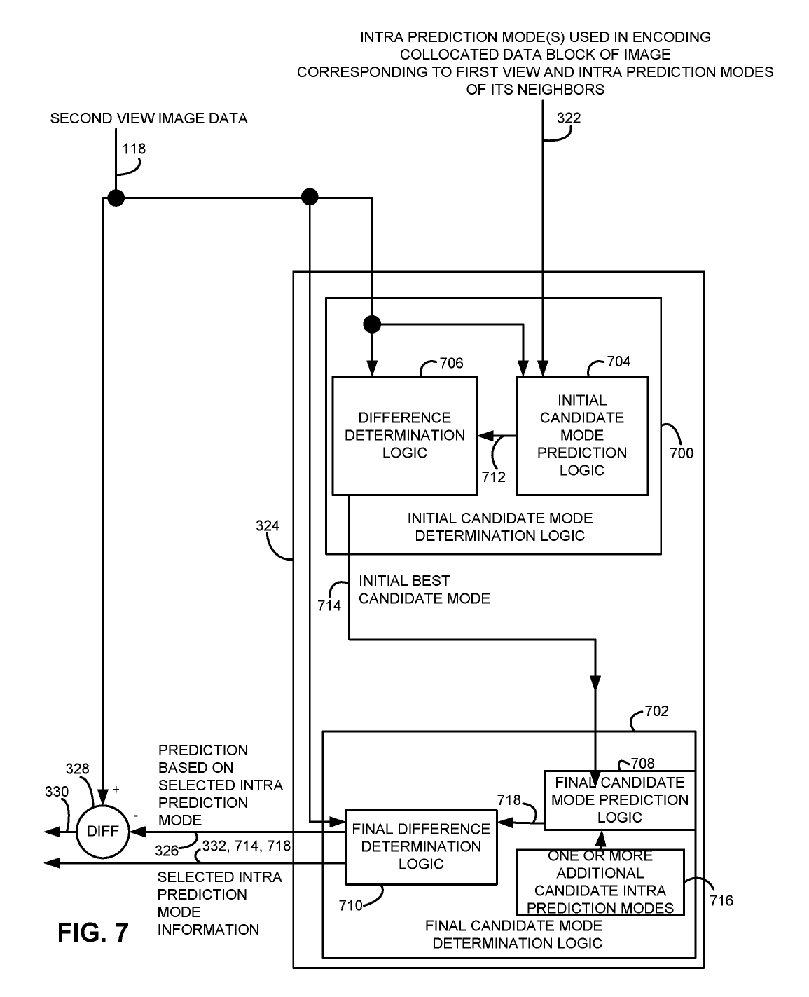

FIG. 7 is a functional block diagram of an example of the enhanced intra prediction mode selection motion compensation logic 324. The enhanced intra prediction mode selection motion compensation logic 324 includes initial candidate mode determination logic 700 and final candidate mode determination control 702. The initial candidate mode determination logic 700 includes initial candidate mode prediction logic 704 and initial difference determination logic 706. The final candidate mode determination logic 702 includes final candidate mode prediction logic 708 and final difference determination logic 710.

In operation, the initial candidate mode determination logic 700 receives the intra prediction modes 322 used in encoding a collocated data block in the base view and prediction modes used on its neighbor blocks. Initial candidate motion prediction logic 704 then determines which intra prediction mode can serve as best candidate intra prediction mode for use in encoding the data block of interest in the dependent view. As further set forth below, by way of example, if the collocated data block 802 has neighbor blocks, the candidate prediction modes 712 that will be provided to the difference determination logic 706 would include the prediction modes used to encode the collocated data block 802 and the prediction modes used to encode the neighboring blocks 1-8 (see FIG. 5).

The determination logic 706 determines a plurality of differences, such as by an SAD calculation, between the data block of the image corresponding to the dependent view and predicted versions of the data block of the image corresponding to the dependent view using each of the candidate prediction modes 712. For example, there may be a candidate prediction mode associated with the collocated data block 802 as well as a plurality of candidate intra prediction modes associated with neighboring blocks 1-8 of the collocated data block of the base view.

The difference determination logic 706 selects one of the plurality of candidate intra prediction modes 712 as an initial best candidate mode 714 which may serve as a final intra prediction mode for encoding the data block 800. This may occur for example when the initial best candidate intra prediction mode is passed out of the final candidate determination logic 702 without change, or passed directly as the selected intra prediction mode information 332.

The selection of the best candidate mode for encoding is based on the plurality of differences that were determined. By way of example, as set forth below, a SAD calculation may be carried out for each candidate intra prediction mode on the data block of interest in a dependent view. The prediction mode generating the lowest SAD value may be selected as the initial best candidate mode which may be the final intra prediction mode if no refinement is done. The encoder 334 then encodes the data block of the image corresponding to the dependent view using the selected final intra prediction mode 332.

If desired, a further refinement of a selection of a final candidate intra prediction mode may be employed using the initial best candidate intra prediction mode. For example, the difference determination logic 706 determines an initial best candidate intra prediction mode 714 for encoding the data block 800 based on predicted versions of the data block of the image corresponding to the dependent view as predicted using each of the plurality of the first and second intra prediction modes 712. The final candidate mode determination logic 702 then evaluates the initial best candidate intra prediction mode 714 and one or more additional candidate intra prediction modes represented as 716 which may, for example, be stored prediction modes based on the prediction direction set forth by any standard. The additional candidate prediction mode 716 which may be, for example, stored in memory, are one or more intra prediction modes that are adjacent in direction to the initial best candidate intra prediction mode 714.

By way of example, referring to FIG. 4, if the initial best candidate mode is mode 6 it has adjacent prediction modes 1 and 4 as further candidate prediction modes. The same SAD calculation process is used in the difference determination logic 710 as is employed by the final difference determination logic 706 to determine if a lower SAD value occurs using adjacent prediction modes to the initial best candidate mode 714. The final candidate mode prediction logic 708 provides the neighboring prediction mode 716 as well as the initial best candidate mode 714 to the final difference determination logic 710 so that the final difference determination logic can carry out the SAD calculations using in this example, all three intra prediction modes on a data block of the dependent view.

The initial candidate motion prediction logic 704 can also evaluate the x, y coordinates of the data block of the dependent view to determine it is at an edge of frame location and the logic is operative to employ a limited number of candidate intra prediction modes for edge data blocks compared to the first and second candidate intra prediction modes available for potential use in encoding other data blocks in a dependent view having surrounding data blocks. As further set forth below for example, a block that is located on the left edge of a frame, has been determined to require only three prediction modes and therefore a faster calculation may be employed if it is determined that an edge block is being evaluated.

The difference determination logic 706, determines a SAD corresponding to each of the first and second candidate intra prediction modes and selects as the final intra prediction mode (in one example the initial best candidate mode) the intra prediction mode having the lowest SAD value.

In the embodiment employing decoding logic, such as decoder 214, the decoder logic may be coupled to a display 126 to decode the encoded data block in the dependent view using the selected final intra prediction mode 332 that may be supplied as part of encoded source MVC image data 202. The decoded block may be then provided to the display as part of a displayed dependent view.

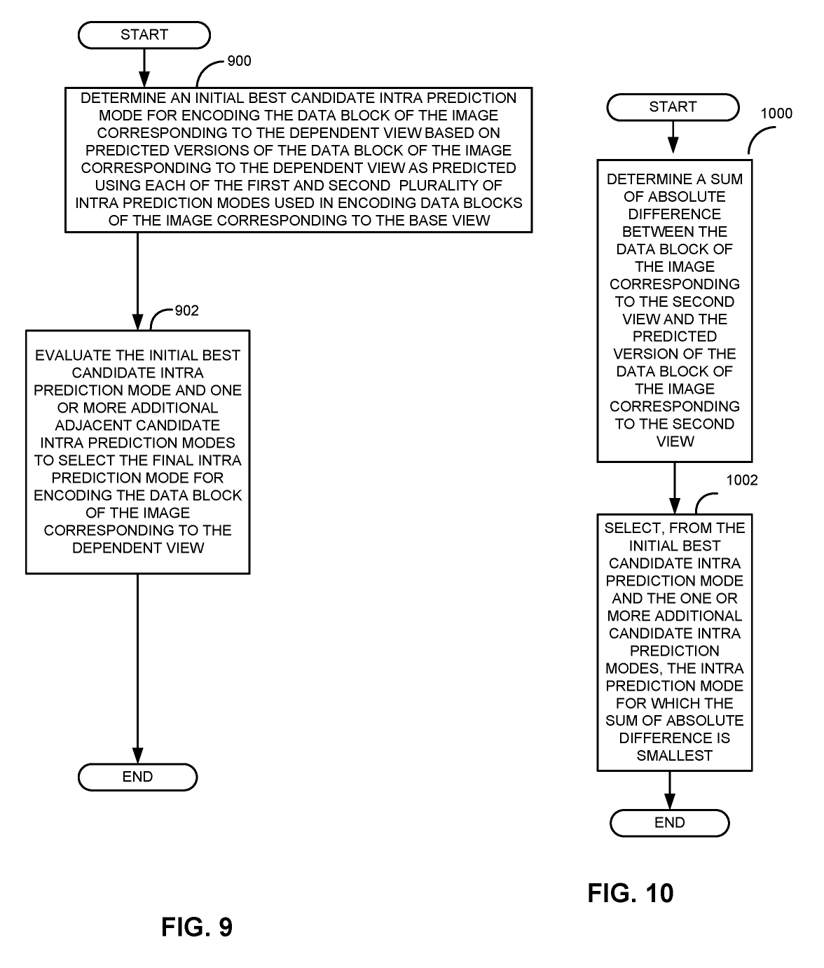

FIG. 9 illustrates one example of a method by the enhanced intra prediction mode selection motion compensation logic 324, for selecting an intra prediction mode for use in multiview coding. As shown in block 900, the method includes determining an initial best candidate intra prediction mode for encoding the data block of the image corresponding to the dependent view, based on predicted versions of the data block of the image corresponding to the dependent view as predicted using each of the first and second plurality of intra prediction modes used in encoding data blocks of the image corresponding to the base view. As shown in block 902, the final candidate mode determination logic 702 may evaluate the initial best candidate intra prediction mode 714 and one or more additional adjacent candidate intra prediction modes to select the final intra prediction mode 718 for encoding the data block of the image corresponding to the dependent view.

FIG. 10 illustrates a method by the enhanced intra prediction mode selection motion compensation logic 324, for selecting an intra prediction mode for use in multiview coding wherein determining a plurality of differences may include determining a SAD between the data block of the image corresponding to the second view and the predicted version of the data block of the image corresponding to the second view (dependent view). This may be done for each of the candidate prediction modes. As shown in block 1002, the method includes selecting, from the initial best candidate intra prediction mode and one or more additional candidate intra prediction modes, the intra prediction mode for which the SAD value is smallest. The corresponding intra prediction mode is then used as the initial best candidate prediction mode.

Stated another way and referring again to FIGS. 4, 5 and 8, instead of calculating the RD cost for blocks in a dependent view, the apparatus calculates the SAD between the original and the reconstructed block.

$$SAD ( m ) = {\sum }_{x , y} \vert Orig ( x , y ) - Pred ( x , y ) \vert$$

Where Orig(x,y) is the original pixel value at position (x,y) and Pred(x,y) is the predicted value using the intra prediction mode m, SAD (m) is the SAD value between the original and the reconstructed block.

If block n is the top left corner block of the dependent view picture (an edge location), then only calculating the SAD value of mode 2 (DC) is performed.

If block n is in the top row of the dependent view picture (an edge location), only the left side neighboring pixels can be used for intra prediction, so according to FIG. 4, only mode 1 (horizontal) and mode 8 (horizontal up) are available in the SAD calculation.

If block n is in the left column of the dependent view picture, the left side neighboring pixels are not available for intra prediction, so only mode 0 (vertical), mode 3 (diagonal down left), and mode 7 (vertical left) are assessed in the SAD calculation.

For the remaining blocks in the dependent view picture, it has both the top and the left neighboring pixels available for intra prediction. Accordingly, the encoder 110 finds its co-located 4×4 block 802 in the base view picture (block n is used as an example in FIG. 8).

If none of block n and its surrounding blocks (block 1, . . . , 8) in the base view picture are encoded as intra 4×4, only mode 2 (DC) for block n in the dependent view picture is evaluated in the SAD calculation.

For non-edge blocks, the encoder 110 uses the available intra 4×4 prediction modes of block n 802 and its surrounding blocks (block 1, . . . , 8) in the base view picture as the prediction mode candidates for block n 800 in the dependent view. The encoder 110 calculates the SAD value of all the candidate intra prediction modes and selects the one with the lowest SAD as the best candidate and final candidate.

If desired, final candidate mode determination logic 702 evaluates the surrounding (adjacent) prediction mode direction of the best candidate for block n in the dependent view. For example, if mode 6 is the best mode resulted as the best candidate, its surrounding modes 1 and 4 (the surrounding prediction mode direction can be referred from FIG. 4) are further evaluated. Among 6, 1, 4, the one with the smallest SAD cost is selected as the final prediction mode 332 for block n 800 in the dependent view.

Among other advantages, example implementations of the system, apparatus, and method described herein recognize that while the captured images in multiview video coding are different, the captured images are nonetheless different representations of, for example, the same objects. The multiview video images are captured against the same object from different angles. As a result, the system, apparatus, and method recognize that there is complementary image information due to the different viewing angles, and that the captured images are highly correlated with one another with redundancy with respect to some of the captured image information. Accordingly, by selecting the intra prediction mode for encoding a data block of the image corresponding to the second view (e.g., dependent view) based on the obtained information (e.g., obtained from a different encoder, or from the same encoder if the same encoder encodes both the image corresponding to the first view and the image corresponding to the second view), the exhaustive RD calculations can be avoided. Example techniques for advantageously selecting the intra prediction mode for encoding the dependent view based on the obtained information, without performing the exhaustive RD calculations and still obtaining an efficient result have been described (e.g., in terms of amount of distortion versus bit cost, as discussed above).

By reducing the computational load needed to select an intra prediction mode for encoding a data block of an image corresponding to a dependent view, the disclosed embodiments benefit systems with limited processing power, allow for higher-quality video playback, particularly for large and/or multiple files being played back at once, and allow video playback devices having the features of the systems, apparatus, and methods to be able to meet increasingly strict performance requirements. Other advantages, and other techniques for advantageously selecting the intra prediction mode for encoding a data block of an image corresponding to a dependent view based on obtained information regarding one or more intra prediction modes used in encoding one or more data blocks of an image corresponding to, for example, a first view (e.g., a base view), are further described herein and/or will be recognized by those of ordinary skill in the art based on the description herein.

The above detailed description of the embodiments and the examples described therein have been presented for the purposes of illustration and description only and not by limitation. It is therefore contemplated that the embodiments cover any and all modifications, variations or equivalents that fall within the spirit and scope of the basic underlying principles disclosed above and claimed herein.

What is claimed is:

1. A method by an encoder for selecting an intra prediction mode for use in multiview video coding (MVC), the multiview video coding providing encoding of at least an image corresponding to a base view and an image corresponding to a dependent view that is dependent upon the base view, the method comprising:
determining a plurality of differences between the data block of the image corresponding to the dependent view and predicted versions of the data block of the image corresponding to the dependent view as predicted using each of a of first candidate prediction mode and a plurality of second candidate intra prediction modes wherein the first candidate intra prediction mode was used in encoding a collocated data block in the corresponding base view and wherein the plurality of second candidate intra prediction modes were used in encoding neighboring blocks of the collocated data block of the base view;
selecting one of the plurality of first and second candidate intra prediction modes as a final intra prediction mode for encoding the data block of the image corresponding to the dependent view based on the plurality of differences; and
encoding the data block of the image corresponding to the dependent view using the selected final intra prediction mode.

2. The method of claim 1 wherein determining the plurality of differences between the data block of the image corresponding to the dependent view and predicted versions of the data block of the image corresponding to the second view as predicted using each of the plurality of first and second candidate intra prediction modes comprises determining a sum of absolute difference (SAD) corresponding to each of the first and second candidate intra prediction modes and selecting as the final intra prediction code, the intra prediction mode having a lowest SAD value.

3. The method of claim 1 further comprising:
determining that the data block of the dependent view is at an edge of frame location and employing a limited number of candidate intra prediction modes to encode edge data blocks compared to the first and second candidate intra prediction modes available for potential use in encoding other data blocks in the dependent view that have surrounding data blocks.

4. The method of claim 1 wherein selecting one of the plurality of first and second candidate intra prediction modes as a final intra prediction mode for encoding the data block of the image corresponding to the dependent view based on the plurality of differences comprises:
determining an initial best candidate intra prediction mode for encoding the data block of the image corresponding to the dependent view based on predicted versions of the data block of the image corresponding to the dependent view as predicted using each of the plurality of first and second candidate intra prediction modes; and
evaluating the initial best candidate intra prediction mode and one or more additional candidate intra prediction modes to select the final intra prediction mode for encoding the data block of the image corresponding to the dependent view wherein the one or more additional candidate intra prediction modes are one or more intra prediction modes adjacent to the initial best candidate intra prediction mode.

5. The method of claim 1 comprising decoding the encoded data block of the image corresponding to the dependent view using the selected final intra prediction mode and displaying the decoded data block as part of a displayed dependent view.

6. An apparatus for selecting an intra prediction mode for use in multiview video coding (MVC), the multiview video coding providing encoding of at least an image corresponding to a base view and an image corresponding to a dependent view that is dependent upon the base view, comprising:
logic operative to:
determine a plurality of differences between the data block of the image corresponding to the dependent view and predicted versions of the data block of the image corresponding to the dependent view as predicted using each of a of first candidate prediction mode and a plurality of second candidate intra prediction modes wherein the first candidate intra prediction mode was used in encoding a collocated data block in the corresponding base view and wherein the plurality of second candidate intra prediction modes were used in encoding neighboring blocks of the collocated data block of the base view;
select one of the plurality of first and second candidate intra prediction modes as a final intra prediction mode for encoding the data block of the image corresponding to the dependent view based on the plurality of differences; and
encode the data block of the image corresponding to the dependent view using the selected final intra prediction mode.

7. The apparatus of claim 6 wherein the logic is operative to determine a sum of absolute difference (SAD) corresponding to each of the first and second candidate intra prediction modes and select as the final intra prediction code, the intra prediction mode having a lowest SAD value.

8. The apparatus of claim 6 wherein the logic is operative to determine that the data block of the dependent view is at an edge of frame location and the logic operative to employ a limited number of candidate intra prediction modes for edge data blocks compared to the first and second candidate intra prediction modes available for potential use in encoding other data blocks in the dependent view that have surrounding data blocks.

9. The apparatus of claim 6 wherein the logic is operative to determine an initial best candidate intra prediction mode for encoding the data block of the image corresponding to the dependent view based on predicted versions of the data block of the image corresponding to the dependent view as predicted using each of the plurality of first and second candidate intra prediction modes; and
evaluate the initial best candidate intra prediction mode and one or more additional candidate intra prediction modes to select the final intra prediction mode for encoding the data block of the image corresponding to the second view wherein the one or more additional candidate intra prediction modes are one or more intra prediction modes adjacent to the initial best candidate intra prediction mode.

10. The apparatus of claim 6 comprising:
a display; and
decoding logic, operatively coupled to the display, operative to decode the encoded data block of the image corresponding to the dependent view using the selected final intra prediction mode and providing the decoded data block to the display as part of a displayed dependent view.

11. A non-transitory storage medium comprising executable instructions that when executed by one or more processors causes the one or more processors to:
determine a plurality of differences between a data block of an image corresponding to a dependent view corresponding to a base view image and predicted versions of the data block of the image corresponding to the dependent view as predicted using each of a of first candidate prediction mode and a plurality of second candidate intra prediction modes wherein the first candidate intra prediction mode was used in encoding a collocated data block in the corresponding base view and wherein the plurality of second candidate intra prediction modes were used in encoding neighboring blocks of the collocated data block of the base view;
select one of the plurality of first and second candidate intra prediction modes as a final intra prediction mode for encoding the data block of the image corresponding to the dependent view based on the plurality of differences; and
encode the data block of the image corresponding to the dependent view using the selected final intra prediction mode.

12. The storage medium of claim 11 comprising executable instructions that when executed by one or more processors causes the one or more processors to:
determine a sum of absolute difference (SAD) corresponding to each of the first and second candidate intra prediction modes and select as the final intra prediction code, the intra prediction mode having a lowest SAD value.

13. The storage medium of claim 11 comprising executable instructions that when executed by one or more processors causes the one or more processors to:
determine that the data block of the dependent view is at an edge of frame location and the logic operative to employ a limited number of candidate intra prediction modes for edge data blocks compared to the first and second candidate intra prediction modes available for potential use in encoding other data blocks in the dependent view that have surrounding data blocks.

14. The storage medium of claim 11 comprising executable instructions that when executed by one or more processors causes the one or more processors to:
determine an initial best candidate intra prediction mode for encoding the data block of the image corresponding to the dependent view based on predicted versions of the data block of the image corresponding to the dependent view as predicted using each of the plurality of first and second candidate intra prediction modes; and
evaluate the initial best candidate intra prediction mode and one or more additional candidate intra prediction modes to select the final intra prediction mode for encoding the data block of the image corresponding to the second view wherein the one or more additional candidate intra prediction modes are one or more intra prediction modes adjacent to the initial best candidate intra prediction mode.
